(19) United States
(12) Patent Application Publication
(10) Pub. No.: US 2025/0199854 A1
(43) Pub. Date: Jun. 19, 2025

(54) PRIORITIZING AN OUTBOUND QUEUE

(71) Applicant: ServiceNow, Inc., Santa Clara, CA (US)

(72) Inventors: Harivijay Srikanth Gunuru, Santa Clara, CA (US); Pramith Thikkavarapu Reddy, San Francisco, CA (US); Karthik Balakrishna, San Francisco, CA (US); Pierce Edward Courtney, San Diego, CA (US); Shreyansh Sharma, Sunnyvale, CA (US); Anil Kumar Bathula, Fremont, CA (US); Nivedita Banerjee, San Diego, CA (US); Mahesh Bingi, Fremont, CA (US)

(21) Appl. No.: 18/544,235

(22) Filed: Dec. 18, 2023

(51) Int. Cl. G06F 9/48

(52) U.S. Cl. CPC G06F 9/4887

(57) ABSTRACT

Various implementations disclosed herein include detecting when a prioritized change task is queued, modifying any related change tasks to have the same priority, and executing the queue according to the modified priorities of the related change tasks.

### TECHNICAL FIELD

The present disclosure relates to prioritizing tasks in an operational queue, and in particular modifying tasks in an existing queue based on a priority of newly added tasks.

### BACKGROUND

A remote process synchronization (RPS) program captures record changes on one instance or system and syncs those changes with another remote instance or system. These record changes are processed as tasks in a first-in, first-out (FIFO) queue. In some cases, a record change captured by the RPS may be critical or time-sensitive and need to be prioritized to the front of the queue. However, prioritizing a task over other tasks can cause problems when a prioritized task is dependent on another task in the queue that has not yet happened (also called data incoherency.)

### BRIEF DESCRIPTION OF THE DRAWINGS

Various embodiments in accordance with the present disclosure will be described with reference to the drawings, in which:

FIG. 1 illustrates a prioritized queue system, according to at least one embodiment;

FIG. 2 illustrates a process for setting prioritizes tasks in a priority queue, according to at least one embodiment;

FIG. 3 illustrates an alternative process for setting prioritized tasks in a priority queue, according to at least one embodiment;

FIG. 4 illustrates another process for setting prioritized tasks in a priority queue, according to at least one embodiment;

FIGS. 5A-5C illustrates priority handling processes of a priority queue, according to at least one embodiment; and

FIG. 6 illustrates a system in which various embodiments can be implemented.

### DETAILED DESCRIPTION

In preceding and following descriptions, various techniques are described. For purposes of explanation, specific configurations and details are set forth in order to provide a thorough understanding of possible ways of implementing techniques. However, it will also be apparent that techniques described below may be practiced in different configurations without specific details. Furthermore, well-known features may be omitted or simplified to avoid obscuring techniques being described.

The remote processing synchronization (RPS) framework is used to synchronize changes made to one system with another system through a one-way or a bidirectional connection. For example, when a new file is added to a local machine, the RPS would be used to copy that file to a cloud backup, thereby maintaining parity for both systems. In practice, the RPS receives many different record change requests (also referred to as “tasks”) from many different users simultaneously. These tasks are arranged and processed in a first-in, first-out (FIFO) queue. However, sometimes a task needs to be prioritized and moved to the top of the queue due to its criticality, but doing so introduces data incoherency that causes errors in the system.

Various implementations disclosed herein include using a prioritized queue system to detect when a prioritized task is added to a queue, to modify any related tasks already in the queue to have the same priority, and to execute the queue according to the modified priorities of the related record change tasks. In an embodiment, when a task enters the queue, the prioritized queue system reads the task's record ID and whether it is flagged as priority. If it is a priority task, then all other tasks that shares that record ID would be also be flagged as a priority. Then, each prioritized task would occur in FIFO order before resuming the regular queue.

In at least one embodiment, record change requests or tasks refer to insert, update, and/or delete operations to add or modify entries in a database. In at least one embodiment, this prioritized queue system only modifies a task's priority level if the task is an insert operation. In at least one embodiment, this prioritized queue system modifies a task's priority level for any type of operation.

As an example embodiment: {C1, A1, B1, C2, A2, D1, A3*} represents a queue of change requests, where A3 is flagged as priority. Other “A” tasks in the sequence are identified and similarly flagged as priority. Then, the queue would progress in FIFO order based on priority, such that the final queue would be processed as: {A1*, A2*, A3*, C1, B1, C2, D1}. This way, the system does not run into data incoherency issues by processing A3 before A1.

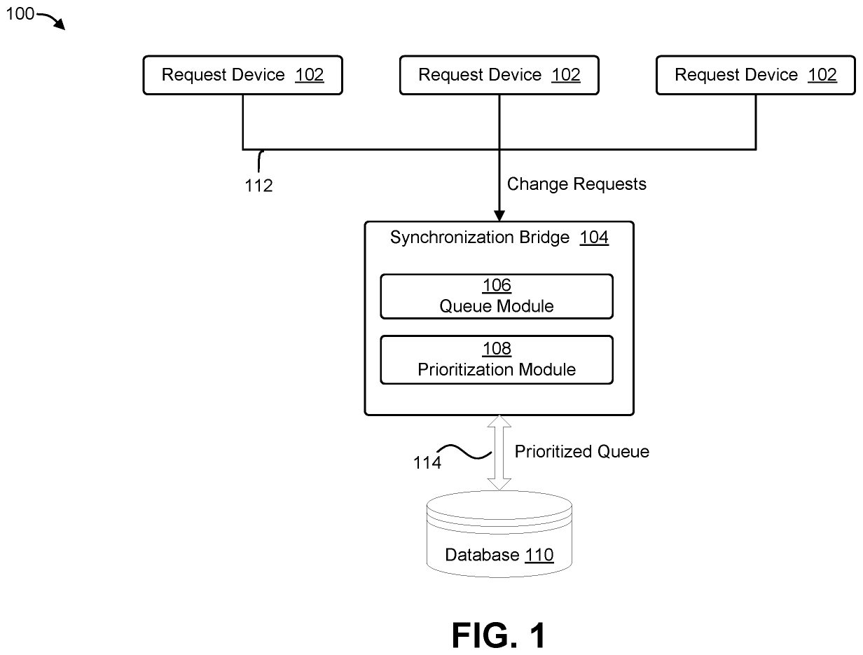

FIG. 1 illustrates a prioritized queue system 100, according to at least one embodiment. In at least one embodiment, system 100 comprises one or more processors that establishes tasks and processes them a prioritized queue 114. In at least one embodiment, system 100 performs a prioritized queue method comprising obtaining a plurality of tasks of a queue, wherein the plurality of tasks is associated with a processing sequence; identifying a priority task within the plurality of tasks, modifying the processing sequence based, at least in part, on the priority task; and initiating execution of the plurality of tasks according to the modified processing sequence.

In at least one embodiment, various request devices 102 transmit record change requests 112 to be synchronized with another system, such as a database 110. In at least one embodiment, change requests 112 from request devices 102 are queued for processing in a round robin manner per remote system. In at least one embodiment, change requests 112 are processed through a synchronization bridge 104 to determine whether an individual change request is to be processed at a certain priority level (also called “processing tier” or “priority tier.”)

In at least one embodiment, the synchronization bridge 104 comprises a processor, such as a graphics processing unit (GPU), general-purpose GPU (GPGPU), parallel processing unit (PPU), central processing unit (CPU)), a data processing unit (DPU), a part of a system on chip (SoC), or combination thereof. In at least one embodiment, synchronization bridge 104 is a component of request devices 102. In at least one embodiment, synchronization bridge 104 is a component of a remote server or a data center having database 110. In at least one embodiment, synchronization bridge 104 is a component of a separate device connected between request device 102 and database 110.

In at least one embodiment, synchronization bridge 104 comprises a processor or device having a queue module 106 that stores change requests or tasks in a queue. In at least one embodiment, the queue describes a processing sequence in which the tasks are to be performed or executed. In at least one embodiment, the change requests or tasks have an identifier, such as a record ID, that indicates what record or table would be changed as a result of performing the task.

In at least one embodiment, synchronization bridge 104 comprises a processor or device having a prioritization module 108 that identifies whether an incoming change request has a defined priority level or processing tier. In at least one embodiment, prioritization module 108 orders the tasks in the processing sequence stored the queue module 106 according to the priority level. In at least one embodiment, high processing tier changes will be expedited and sent sooner than other, less important changes to modify the database 110. In at least one embodiment, if the incoming change request is a prioritized task or has a defined priority level, prioritization module 108 identifies other tasks that have a shared identifier with the incoming change request. In at least one embodiment, prioritization module 108 modifies the priority level for other tasks with the shared identifier to be the same as the priority level of the incoming change request. In at least one embodiment, prioritization module 108 updates the processing sequence in the queue module 106 to first perform the tasks that have modified priority.

In at least one embodiment, queue module 106 outputs the prioritized queue 114 after the processing sequence has been modified by the prioritization module 108. In at least one embodiment, the tasks are processed and executed in the queue processing order and the change requests are applied to database 110.

In at least one embodiment, incoming change requests 112 are arranged as tasks having a defined priority level. In at least one embodiment, the defined priority level is one of “high”, “medium”, “low”, or “none.” In at least one embodiment, the defined priority level is one of “high priority” or “normal priority.”

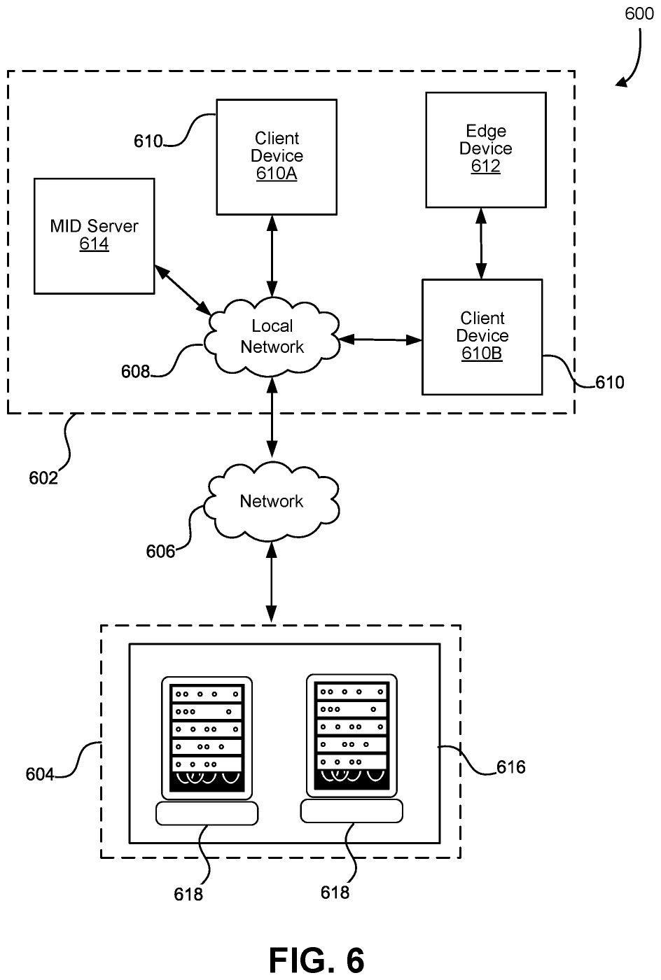

In an embodiment, some or all of the processes of system 100 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process of system 100 may be performed by any suitable system, such as the computing device 600 of FIG. 6.

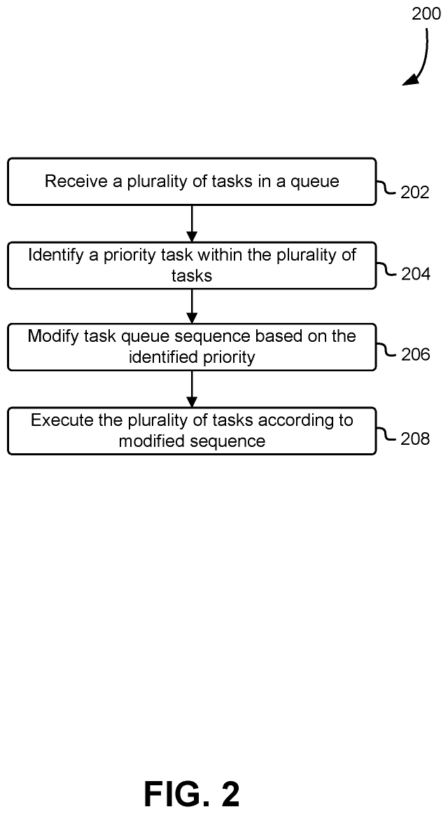

FIG. 2 illustrates a process 200 for setting prioritizes tasks in a priority queue, according to at least one embodiment. In at least one embodiment, process 200 can be performed by the system in FIG. 1 (e.g., prioritized queue system 100) to receive change requests and process them in a queue where some tasks are given higher priority over others.

In at least one embodiment, at step 202, a system (e.g., prioritized queue system 100 of FIG. 1) receives a plurality of tasks in a queue. In at least one embodiment, the plurality of tasks is received from various devices (e.g., request devices 102 of FIG. 1). In at least one embodiment, the plurality of tasks represent a plurality of record change requests to be applied to a remote system (e.g., database 110 of FIG. 1). In at least one embodiment, the plurality of tasks is received in a bridge (e.g., synchronization bridge 104 of FIG. 1) that connects a first device with a remote system. In at least one embodiment, the plurality of tasks are arranged in a queue stored in a processing module (e.g., queue module 106 of FIG. 1).

In at least one embodiment, at step 204, the system identifies a priority task within the plurality of tasks. In at least one embodiment, a processing module (e.g., prioritization module 108) identifies whether a task of the plurality of tasks has one of four priority levels: “high”, “medium”, “low”, or “none.” In at least one embodiment, the processing module identifies whether a task of the plurality of tasks has one of two priority levels: “high priority” or “normal priority.”

In at least one embodiment, the plurality of tasks are defined as capture definitions including various fields that indicate the source table and fields that need to be synced with a target database. In at least one embodiment, the capture definition includes a field in a definition table indicating a priority level or processing tier. In at least one embodiment, this processing tier is a string, label, text, entry, or selection of a priority level (e.g., one of four priority levels, “high”, “medium”, “low”, or “none”, or one of two priority levels, “high priority” or “normal priority”).

In at least one embodiment, at step 206, after the system has identified the priority level of the task, then the system modifies the task queue to rearrange the processing sequence according to the priority level. In at least one embodiment, high processing tier record changes are sent and processed before important changes, as indicated by the priority levels.

In at least one embodiment, at step 208, the system executes the plurality of tasks and applies the changes to the remote system according to the modified processing sequence of tasks in the queue.

Examples of this modified processing sequence is shown in Tables 1 and 2:

TABLE 1
Different Records with Different Processing Tiers

| Sequence | Processing Tier | Source Table | Record | Change |
|---|---|---|---|---|
| SEQ 1 | MEDIUM | TABLE A | 005 | CREATE |
| SEQ 2 | HIGH | TABLE A | 006 | CREATE |
| SEQ 3 | LOW | TABLE A | 007 | CREATE |

Modified Processing Sequence: SEQ 2, SEQ 1, SEQ 3. (Tasks with a higher processing tier is processed first.)

TABLE 2
Different Records with Same Processing Tiers

| Sequence | Processing Tier | Source Table | Record | Change |
|---|---|---|---|---|
| SEQ 1 | LOW | TABLE A | 008 | CREATE |
| SEQ 2 | MEDIUM | TABLE A | 009 | CREATE |
| SEQ 3 | MEDIUM | TABLE A | 010 | CREATE |

Modified Processing Sequence: SEQ 2, SEQ 3, SEQ 1. (Tasks with same processing tiers are processed in order received.)

In an embodiment, some or all of process 200 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 200 may be performed by any suitable system, such as the computing device 600 of FIG. 6.

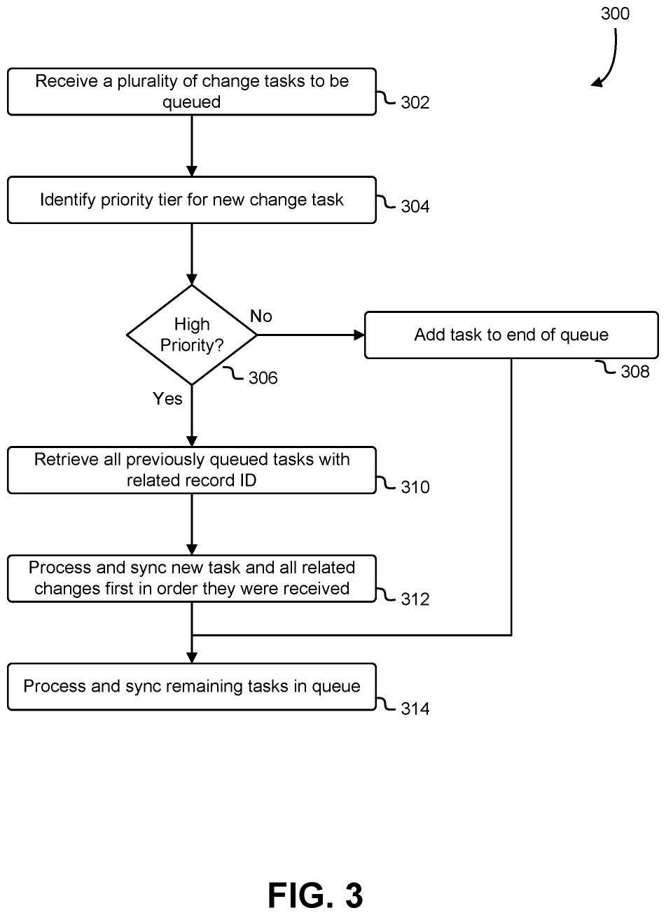

FIG. 3 illustrates a process 300 for setting prioritized tasks in a priority queue, according to at least one embodiment. In at least one embodiment, a system, such as the system described in FIG. 1 (e.g., prioritized queue system 100 of FIG. 1) performs process 300 to receive change requests and process them in a queue where identified tasks are given higher priority over others. In at least one embodiment, process 300 sets prioritized tasks in a priority queue, according to one of two priority levels (e.g., high priority or normal priority.)

In at least one embodiment, at step 302, a system receives a plurality of change tasks to be added to a queue. In at least one embodiment, the plurality of change tasks is received from various devices (e.g., request devices 102 of FIG. 1). In at least one embodiment, the plurality of change tasks represent a plurality of record change requests to be applied to a remote system (e.g., database 110 of FIG. 1). In at least one embodiment, the plurality of change tasks is received in a bridge (e.g., synchronization bridge 104 of FIG. 1) that connects a first device with a remote system. In at least one embodiment, the plurality of change tasks are arranged in a queue stored in a processing module (e.g., queue module 106 of FIG. 1).

In at least one embodiment, at step 304, the system identifies a priority tier for an incoming change task from the plurality of change tasks. In at least one embodiment, a processing module (e.g., prioritization module 108 of FIG. 1) identifies whether a task of the plurality of change tasks has high priority.

In at least one embodiment, at step 306, if the task was not identified to have high priority, then the process proceeds to step 308. In at least one embodiment, at step 308, the task is added to the end of the queue to be performed last. In at least one embodiment, at step 314, the system executes the tasks in the queued processing order and applies the changes to the remote system.

In at least one embodiment, at step 306, if the task is identified to have high priority, then the process proceeds to step 310. In at least one embodiment, at step 310, a processing module (e.g., prioritization module 108 or queue module 106 of FIG. 1) retrieves any previously queued tasks from the queue that have a same identifier, related identifier, or record ID as the identified high priority task and sets the priorities of the existing tasks to also have high priority.

In at least one embodiment, at step 312, the system processes all tasks marked as high priority in the queue in the processing sequence order in which they were received. In at least one embodiment, a received order is determined based on a timestamp associated with an incoming change request or task. In at least one embodiment, the high priority tasks are performed before all non-priority tasks. In at least one embodiment, at step 314, the system executes the tasks in the queued processing order and applies the changes to the remote system.

In an embodiment, some or all of process 300 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 300 may be performed by any suitable system, such as the computing device 600 of FIG. 6.

In at least one embodiment, performing process 200 of FIG. 2 and by performing process 300, a prioritized queue can be achieved while avoiding data coherency issues caused by different processing tiers. In at least one embodiment, performing process 300 ensures that all changes related to the priority task are captured and sent together, maintaining data consistency.

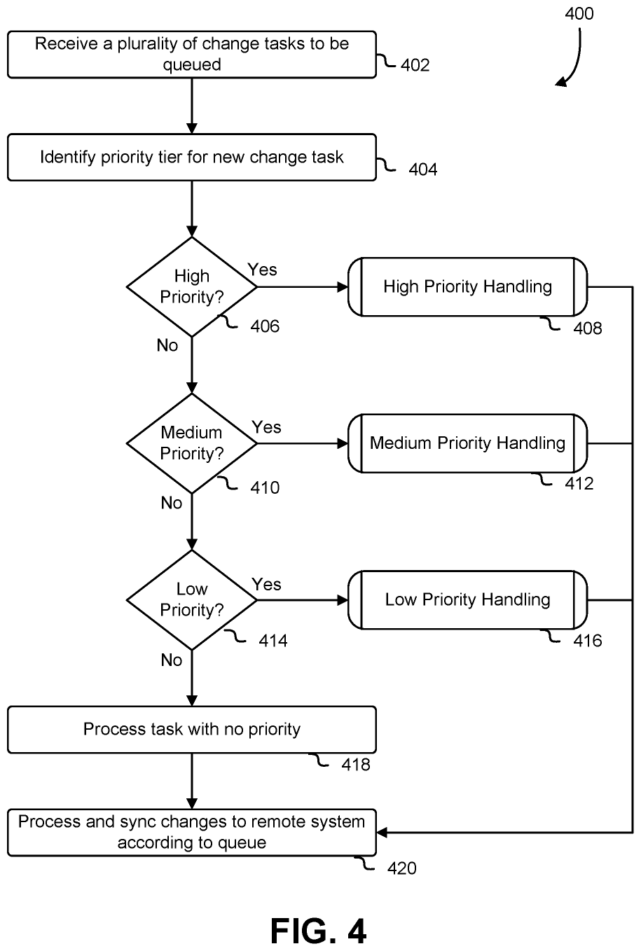

FIG. 4 illustrates a process 400 for setting prioritized tasks in a priority queue, according to at least one embodiment. In at least one embodiment, a system such as the system described in FIG. 1 (e.g., prioritized queue system 100 of FIG. 1) performs process 400 to receive change requests and process them in a queue where identified tasks are given higher priority over others. In at least one embodiment, process 400 sets prioritized tasks in a priority queue, according to one of four priority levels (e.g., high priority, medium priority, low priority, or no priority.)

In at least one embodiment, at step 402, a system receives a plurality of change tasks to be added to a queue (e.g., the change tasks received 202 of FIG. 2). In at least one embodiment, the plurality of change tasks is received from various devices (e.g., request devices 102 of FIG. 1). In at least one embodiment, the plurality of change tasks represent a plurality of record change requests to be applied to a remote system (e.g., database 110 of FIG. 1). In at least one embodiment, the plurality of change tasks is received in a bridge (e.g., synchronization bridge 104 of FIG. 1) that connects a first device with a remote system. In at least one embodiment, the plurality of change tasks are arranged in a queue stored in a processing module (e.g., queue module 106 of FIG. 1).

In at least one embodiment, at step 404, the system identifies a priority tier for an incoming change task from the plurality of change tasks. In at least one embodiment, a processing module (e.g., prioritization module 108 of FIG. 1) identifies whether a task of the plurality of change tasks has high, medium, low, or no priority. In at least one embodiment, a task has a processing tier field (e.g., field entry) where the high, medium, low, or no priority label can be assigned or entered.

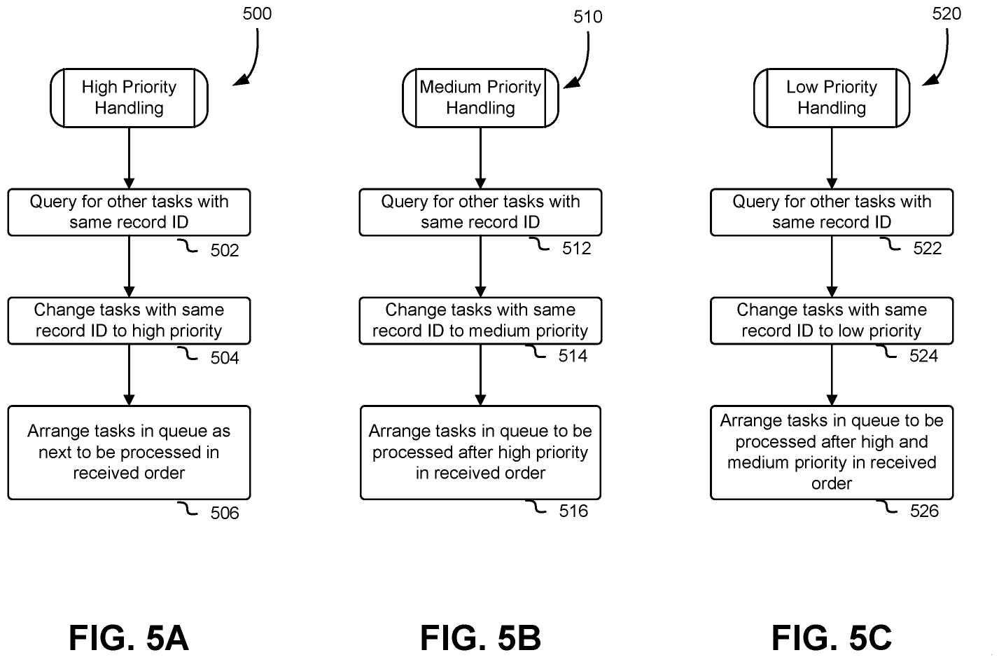

In at least one embodiment, at step 406, if the task is identified to have high priority, then the process proceeds to step 408. In at least one embodiment, at step 408, the system performs high priority handling (described with reference to FIG. 5A) of the task and adds the task to the front of the queue.

In at least one embodiment, at step 406, if the task is not identified to have high priority, then the process proceeds to step 410. In at least one embodiment, at step 410, if the task is identified to have medium priority, then the process proceeds to step 412. In at least one embodiment, at step 412, the system performs medium priority handling (described with reference to FIG. 5B) of the task and adds the task to the queue after the high priority tasks.

In at least one embodiment, at step 410, if the task is not identified to have medium priority, then the process proceeds to step 414. In at least one embodiment, at step 410, if the task is identified to have medium priority, then the process proceeds to step 416. In at least one embodiment, at step 416, the system performs medium priority handling (described with reference to FIG. 5C) of the task and adds the task to the queue after both the high and medium priority tasks.

In at least one embodiment, at step 414, if the task is not identified to have low priority, then the process proceeds to step 418. In at least one embodiment, at step 418, the task is queued and added to the processing sequence as having no priority. In at least one embodiment, a task having no priority is queued with a default priority tier (e.g., a tier preset by a user.) In at least one embodiment, a task having no priority is queued as defaulting to medium priority or low priority. In at least one embodiment, a task having no priority is queued after low priority tasks.

In at least one embodiment, at step 420, the system executes and syncs all tasks marked as high priority in the queue in the processing sequence order in which they were received and applies the changes to the remote system. After the high priority tasks, the system executes and syncs tasks marked as medium priority in the queue in the processing sequence order in which they were received and applies the changes to the remote system. After the medium priority tasks, the system executes and syncs tasks marked as low priority in the queue in the processing sequence order in which they were received and applies the changes to the remote system. In at least one embodiment, a received order of a plurality of tasks or change requests is determined based on a timestamp indicating when the tasks were received at the synchronization bridge 104.

In an embodiment, some or all of process 400 (or any other processes described such as process 200 of FIG. 2, process 300 of FIG. 3, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 400 may be performed by any suitable system, such as the computing device 600 of FIG. 6.

FIGS. 5A, 5B, and 5C illustrates processes 500, 510, and 520 for priority handling of a priority queue, according to at least one embodiment. In at least one embodiment, high priority handling process 500, medium priority handling process 510, and low priority handling process 520 correspond to steps 408, 412, and 416, respectively, of FIG. 4. In at least one embodiment, a system (e.g., prioritized queue system 100) performs processes 500, 510, and 520 to set tasks in a prioritized queue in a specific processing sequence.

FIG. 5A illustrates high priority handling process 500. In at least one embodiment, at step 502, a processing module (e.g., prioritization module 108 or queue module 106) of the system queries for and retrieves any previously queued tasks from the queue that have a same identifier, related identifier, or record ID as the identified high priority task. In at least one embodiment, at step 504, the system changes and sets the priorities of the retrieved tasks to also have high priority. In at least one embodiment, at step 506, the tasks are arranged in the queue as next in the processing sequence, according to the order in which the high priority tasks were received. In at least one embodiment, a received order of high priority tasks is determined based on a timestamp indicating when the high priority tasks were received at the synchronization bridge 104.

FIG. 5B illustrates medium priority handling process 510. In at least one embodiment, at step 512, a processing module (e.g., prioritization module 108 or queue module 106 of FIG. 1) of the system queries for and retrieves any previously queued tasks from the queue that have a same identifier, related identifier, or record ID as the identified medium priority task. In at least one embodiment, at step 514, the system changes and sets the priorities of the retrieved tasks to also have medium priority. In at least one embodiment, at step 516, the tasks are arranged in the queue as immediately following when all high priority tasks are complete in the processing sequence, according to the order in which the medium priority tasks were received. In at least one embodiment, a received order of medium priority tasks is determined based on a timestamp indicating when the medium priority tasks were received at the synchronization bridge 104.

FIG. 5C illustrates low priority handling process 520. In at least one embodiment, at step 522, a processing module (e.g., prioritization module 108 or queue module 106 of FIG. 1) of the system queries for and retrieves any previously queued tasks from the queue that a same identifier, related identifier, or record ID as the identified low priority task. In at least one embodiment, at step 524, the system changes and sets the priorities of the retrieved tasks to also have medium priority. In at least one embodiment, at step 526, the tasks are arranged in the queue as immediately following high priority tasks in the processing sequence, according to the order in which the low priority tasks were received. In at least one embodiment, a received order of low priority tasks is determined based on a timestamp indicating when the low priority tasks were received at the synchronization bridge 104 of FIG. 1.

In an embodiment, some or all of process 500 (or any other processes described, or variations and/or combinations of those processes) may be performed under the control of one or more computer systems configured with executable instructions and/or other data and may be implemented as executable instructions executing collectively on one or more processors. The executable instructions and/or other data may be stored on a non-transitory computer-readable storage medium (e.g., a computer program persistently stored on magnetic, optical, or flash media). For example, some or all of process 500 may be performed by any suitable system, such as the computing device 600 of FIG. 6.

In at least one embodiment, by performing process 400 and corresponding processes 500, 510, and 520, a prioritized queue can be achieved while avoiding data incoherency issues caused by different processing tiers. In at least one embodiment, performing processes 400, 500, 510, and 520 promotes the priority of related changes to ensure their order within the queue aligns with the high priority change.

FIG. 6 illustrates a system 600 in which various embodiments can be implemented. The system 600 may include a client network 602 and a provider platform 604 that are operably connected via a network 606 (e.g., the Internet). In an embodiment, the client network 602 may be a private local network 608, such as a local area network (LAN) that includes a variety of network devices that include, but are not limited to, switches, servers, and routers. In an embodiment, the client network 602 can comprise an enterprise network that can include one or more LANs, virtual networks, data centers, and/or other remote networks. In an embodiment, the client network 602 can be operably connected to one or more client devices 610 such as example client device 610A, 610B so that the client devices 610 are able to communicate with each other and/or with the provider platform 604. In an embodiment, the client devices 610 can be computing systems and/or other types of computing devices generally referred to as Internet of Things (IoT) devices that can access cloud computing services, for example, via a web browser application or via an edge device 612 that may act as a gateway between one or more client devices 610 and the platform 604 (e.g., second client device 610B). In an embodiment, the client network 602 can include a management, instrumentation, and discovery (MID) server 614 that facilitates communication of data between the network hosting the platform 604, other external applications, data sources, and services, and the client network 602. In an embodiment, the client network 602 may also include a connecting network device (e.g., a gateway or router) or a combination of devices that implement a customer firewall or intrusion protection system.

In an embodiment, the client network 602 can be operably coupled to the network 606, which may include one or more suitable computing networks, such a large area network (LAN), wide area networks (WAN), the Internet, and/or other remote networks, that are operable to transfer data between the client devices 610 and the provider platform 604. In an embodiment, one or more computing networks within network 606 can comprise wired and/or wireless programmable devices that operate in the electrical and/or optical domain. For example, network 606 may include wireless networks, such as cellular networks (e.g., Global System for Mobile Communications (GSM) based cellular network), WIN networks, and/or other suitable radio-based networks. The network 606 may also employ any suitable network communication protocols, such as Transmission Control Protocol (TCP), Internet Protocol (IP), and the like. In an embodiment, network 606 may include a variety of network devices, such as servers, routers, network switches, and/or other suitable network hardware devices configured to transport data over the network 606.

In an embodiment, the provider platform 604 may be a remote network (e.g., a cloud network) that is able to communicate with the client devices 610 via the client network 602 and network 606. In an embodiment, the provider platform 604 can comprise a configuration management database (CMDB) platform. In an embodiment, the provider platform 604 provides additional computing resources to the client devices 610 and/or the client network 602. For example, by utilizing the provider platform 604, in some examples, users of the client devices 610 can build and execute applications for various enterprise, IT, and/or other organization-related functions. In one embodiment, the provider platform 604 can be implemented on the one or more data centers 616, where each data center 616 can correspond to a different geographic location in some examples. In an embodiment, one or more the data centers 616 includes a plurality of servers 618 (also referred to in some examples as application nodes, virtual servers, application servers, virtual server instances, application instances, application server instances, or the like), where each server 618 can be implemented on a physical computing system, such as a single electronic computing device (e.g., a single physical hardware server) or across multiple-computing devices (e.g., multiple physical hardware servers). Examples of servers 618 can include a virtual server, a web server (e.g., a unitary Apache installation), an application server (e.g., a unitary Java Virtual Computer), and/or a database server.

To utilize computing resources within the provider platform 604, in an embodiment, network operators may choose to configure the data centers 616 using a variety of computing infrastructures. In an embodiment, one or more of the data centers 616 can be configured using a multi-instance cloud architecture to provide every customer with its own unique customer instance or instances. For example, a multi-instance cloud architecture of some embodiments can provide each customer instance with its own dedicated application server and dedicated database server. In some examples, the multi-instance cloud architecture could deploy a single physical or virtual server 618 and/or other combinations of physical and/or virtual servers 618, such as one or more dedicated web servers, one or more dedicated application servers, and one or more database servers, for each customer instance. In an embodiment of a multi-instance cloud architecture, multiple customer instances can be installed on one or more respective hardware servers, where each customer instance is allocated certain portions of the physical server resources, such as computing memory, storage, and processing power. By doing so, in some examples each customer instance has its own unique software stack that provides the benefit of data isolation, relatively less downtime for customers to access the platform 604, and customer-driven upgrade schedules.

In some embodiments, the provider platform 604 includes a computer-generated data management server that receives, via network 606 and/or an internal network within or across different data centers, computer-generated data for storage and analysis. For example, log entries can be sent from client devices/servers 610, MID server 614 (e.g., agent server acting as the intermediary in client network 602 to facilitate access to client network 602 by the network hosting the platform 604), and/or servers in data centers 616 to a log management server in data centers 616.

Although FIG. 6 illustrates a specific embodiment of a cloud computing system 600, the disclosure is not limited to the specific embodiments illustrated in FIG. 6. For instance, although FIG. 6 illustrates that the platform 604 is implemented using data centers, other embodiments of the platform 604 are not limited to data centers and can utilize other types of remote network infrastructures. Some embodiments may combine one or more different virtual servers into a single virtual server. The use and discussion of FIG. 6 are only examples to facilitate ease of description and explanation and are not intended to limit the disclosure to the specific examples illustrated therein. In an embodiment, the respective architectures and frameworks discussed with respect to FIG. 6 can incorporate suitable computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

The various embodiments further can be implemented in a wide variety of operating environments, which in some cases can include one or more user computers, computing devices or processing devices that can be used to operate any of a number of applications. In an embodiment, user or client devices include any of a number of computers, such as desktop, laptop or tablet computers running a standard operating system, as well as cellular (mobile), wireless and handheld devices running mobile software and capable of supporting a number of networking and messaging protocols, and such a system also includes a number of workstations running any of a variety of commercially available operating systems and other known applications for purposes such as development and database management. In an embodiment, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

In an embodiment, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In an embodiment, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In an embodiment, the one or more servers are also capable of executing programs or scripts in response to requests from user devices, such as by executing one or more web applications that are implemented as one or more scripts or programs written in any programming language, such as Java®, C, C # or C++, or any scripting language, such as Ruby, PHP, Perl, Python or TCL, as well as combinations thereof. In an embodiment, the one or more servers also include database servers, including without limitation those commercially available from Oracle®, Microsoft®, Sybase®, and IBM® as well as open-source servers such as MySQL, Postgres, SQLite, MongoDB, and any other server capable of storing, retrieving, and accessing structured or unstructured data. In an embodiment, a database server includes table-based servers, document-based servers, unstructured servers, relational servers, non-relational servers, or combinations of these and/or other database servers.

In an embodiment, the system includes a variety of data stores and other memory and storage media as discussed above that can reside in a variety of locations, such as on a storage medium local to (and/or resident in) one or more of the computers or remote from any or all the computers across the network. In an embodiment, the information resides in a storage-area network (“SAN”) familiar to those skilled in the art and, similarly, any necessary files for performing the functions attributed to the computers, servers or other network devices are stored locally and/or remotely, as appropriate. In an embodiment where a system includes computerized devices, each such device can include hardware elements that are electrically coupled via a bus, the elements including, for example, at least one central processing unit (“CPU” or “processor”), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In an embodiment, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In an embodiment, the system and various devices also typically include a number of software applications, modules, services, or other elements located within at least one working memory device, including an operating system and application programs, such as a client application or web browser. In an embodiment, customized hardware is used and/or particular elements are implemented in hardware, software (including portable software, such as applets), or both. In an embodiment, connections to other computing devices such as network input/output devices are employed.

In an embodiment, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

At least one embodiment of the disclosure can be described in view of the following clauses:
1. A method, comprising:
obtaining a plurality of tasks of a queue, wherein the plurality of tasks is associated with a processing sequence;
identifying a priority task within the plurality of tasks;
modifying the processing sequence based, at least in part, on the priority task; and
initiating execution of the plurality of tasks according to the modified processing sequence.
2. The method of clause 1, wherein a priority level of the plurality of tasks is labeled as one of high, medium, low, and none in a field entry.
3. The method of clause 1, further comprising:
querying for other tasks in the queue that have a related identifier to the identified priority task; and
modifying a priority level of the other tasks having the related identifier.
4. The method of clause 1, wherein the modified processing sequence is arranged in an order based, at least in part, on a field entry in the plurality of tasks.
5. The method of clause 1, wherein the plurality of tasks within a same priority level are processed in an order received.
6 The method of clause 1, further comprising:
promoting an existing task in the queue to a high priority level; and
deferring execution of the priority task until after the existing task is first performed.
7. The method of clause 1, further comprising setting a default priority level when a priority level is none.
8. A system, comprising:
one or more processors; and
memory including computer-executable instructions that, if executed by the one or more processors, cause the system to:
   obtain a plurality of tasks of a queue, wherein the plurality of tasks is associated with a processing sequence;
   identify a priority task within the plurality of tasks;
   modify the processing sequence based, at least in part, on the priority task; and
   initiate execution of the plurality of tasks according to the modified processing sequence.
9. The system of clause 8, wherein the one or more processors are to adjust a priority level of one or more other tasks related to the priority task to have a different label.
10. The system of clause 8, wherein the queue is a first-in, first-out (FIFO) queue.
11. The system of clause 8, wherein the one or more processors are to cause the system to arrange the plurality of priority tasks of the modified processing sequence in a descending order starting with high priority tasks.
12. The system of clause 8, wherein the tasks within a same priority level are processed based, at least in part, on a timestamp.
13. The system of clause 8, wherein the one or more processors further cause the system to:
query for other tasks in the queue that have a record ID corresponding to the identified priority task; and
modify a priority level of the other tasks comprising the record ID.
14. The system of clause 8, wherein the one or more processors further cause the system to set a default priority level when a priority level is none.
15. A non-transitory computer-readable storage medium having stored thereon executable instructions which, when executed by one or more processors of a computer system, cause the computer system to:
obtain a plurality of tasks of a queue, wherein the plurality of tasks is associated with a processing sequence;
identify a priority task within the plurality of tasks;
modify the processing sequence based, at least in part, on the priority task; and
initiate execution of the plurality of tasks according to the modified processing sequence.
16. The non-transitory computer-readable storage medium of clause 15, wherein the priority task comprises a processing tier field that is one of high priority and normal priority.
17. The non-transitory computer-readable storage medium of clause 15, wherein the one or more processors further cause the computer system to process and sync the plurality of tasks in the queue in the order received to maintain data coherency.
18. The non-transitory computer-readable storage medium of clause 15, wherein the modified processing sequence is arranged to comprise one or more priority tasks related to the priority task be repositioned to the top of the queue.
19. The non-transitory computer-readable storage medium of clause 15, wherein the tasks within a same priority level are processed in an order received.
20. The non-transitory computer-readable storage medium of clause 15, wherein the one or more processors further cause the computer system to:
query for other tasks in the queue that have a related identifier to the identified priority task; and
modify a priority level of the other tasks.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—For example, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A method, comprising:
obtaining a plurality of tasks of a queue, wherein the plurality of tasks is associated with a processing sequence;
identifying a priority task within the plurality of tasks;
modifying the processing sequence based, at least in part, on the priority task; and
initiating execution of the plurality of tasks according to the modified processing sequence.

2. The method of claim 1, wherein a priority level of the plurality of tasks is labeled as one of high, medium, low, and none in a field entry.

3. The method of claim 1, further comprising:
querying for other tasks in the queue that have a related identifier to the identified priority task; and
modifying a priority level of the other tasks having the related identifier.

4. The method of claim 1, wherein the modified processing sequence is arranged in an order based, at least in part, on a field entry in the plurality of tasks.

5. The method of claim 1, wherein the plurality of tasks within a same priority level are processed in an order received.

6. The method of claim 1, further comprising:
promoting an existing task in the queue to a high priority level; and
deferring execution of the priority task until after the existing task is first performed.

7. The method of claim 1, further comprising setting a default priority level when a priority level is none.

8. A system, comprising:
one or more processors; and
memory including computer-executable instructions that, if executed by the one or more processors, cause the system to:
obtain a plurality of tasks of a queue, wherein the plurality of tasks is associated with a processing sequence;
identify a priority task within the plurality of tasks;
modify the processing sequence based, at least in part, on the priority task; and
initiate execution of the plurality of tasks according to the modified processing sequence.

9. The system of claim 8, wherein the one or more processors are to adjust a priority level of one or more other tasks related to the priority task to have a different label.

10. The system of claim 8, wherein the queue is a first-in, first-out (FIFO) queue.

11. The system of claim 8, wherein the one or more processors are to cause the system to arrange the plurality of priority tasks of the modified processing sequence in a descending order starting with high priority tasks.

12. The system of claim 8, wherein the tasks within a same priority level are processed based, at least in part, on a timestamp.

13. The system of claim 8, wherein the one or more processors further cause the system to:
query for other tasks in the queue that have a record ID corresponding to the identified priority task; and
modify a priority level of the other tasks comprising the record ID.

14. The system of claim 8, wherein the one or more processors further cause the system to set a default priority level when a priority level is none.

15. A non-transitory computer-readable storage medium having stored thereon executable instructions which, when executed by one or more processors of a computer system, cause the computer system to:
obtain a plurality of tasks of a queue, wherein the plurality of tasks is associated with a processing sequence;
identify a priority task within the plurality of tasks;
modify the processing sequence based, at least in part, on the priority task; and
initiate execution of the plurality of tasks according to the modified processing sequence.

16. The non-transitory computer-readable storage medium of claim 15, wherein the priority task comprises a processing tier field that is one of high priority and normal priority.

17. The non-transitory computer-readable storage medium of claim 15, wherein the one or more processors further cause the computer system to process and sync the plurality of tasks in the queue in the order received to maintain data coherency.

18. The non-transitory computer-readable storage medium of claim 15, wherein the modified processing sequence is arranged to comprise one or more priority tasks related to the priority task be repositioned to the top of the queue.

19. The non-transitory computer-readable storage medium of claim 15, wherein the tasks within a same priority level are processed in an order received.

20. The non-transitory computer-readable storage medium of claim 15, wherein the one or more processors further cause the computer system to:
query for other tasks in the queue that have a related identifier to the identified priority task; and
modify a priority level of the other tasks.
